(19) United States
(12) Patent Application Publication
(10) Pub. No.: US 2012/0115753 A1
(43) Pub. Date: May 10, 2012

(54) Method for Drug Screening For Agents for the Treatment of Hepatitis C Virus Infection

(76) Inventor: Albert P. Li, Columbia, MD (US)

(21) Appl. No.: 12/940,039

(22) Filed: Nov. 4, 2010

(51) Int. Cl. C40B 30/06; C40B 50/00; C40B 50/06; C40B 40/02

(52) U.S. Cl. 506/10; 506/14; 506/23; 506/26

(57) ABSTRACT

The present invention describes an improved method of screening of anti HCV agents that may have an efficacy for treatment of hepatitis C virus. The invention includes cryogenic hepatocyte bank, wherein the bank includes multiple hepatocytes collected from multiple HCV patients and the hepatocyte bank includes more than one genotype of HCV. The method involves the isolation and cryopreservation of HCV infected hepatocytes from multiple infected individuals. The isolated and cryopreserved hepatocytes are stored in a cryopreservation bank. These stored hepatocytes then are cultured in a culture medium, and anti-HCV screening of the hepatocytes is done by subjecting HCV infected hepatocytes in parallel to action of different anti-HCV compounds at various concentrations. Effective anti-HCV agents will lead to a decrease in HCV content in the cultures.

### TECHNICAL FIELD

The field of the invention generally relates to a novel method of selection of drug candidates for treatment of hepatitis C virus infection.

### BACKGROUND

The hepatitis C virus or HCV, first identified in 1989, is the major agent of the viral infections that are known as non-A non-B hepatitis. The term “non-A non-B” was introduced in the 1970s to describe hepatitis of which the etiological agents, not yet identified, appear serologically different from hepatitis A and B based on immunological tests. HCV infection has been reported to infect 170 million individuals worldwide. HCV infection is often fatal. The current treatment, a combination of interferon and ribavirin, is only moderately effective in the control of the progress, does not provide a cure, and is associated with myriad undesirable side effects.

A major problem with the discovery and development of anti-HCV drugs is the absence of an effective experimental system for the evaluation of pharmacological effects. The general approach is to screen for the inhibition of the expression of HCV genes using cell lines transfected with portions of the HCV genome by culturing the infected cell-lines in a suitable medium in a tissue culture vessel such as well, plate or a flask and adding the anti-HCV agent to the medium. This screening assay has limited use as neither the HCV genome nor the cell lines are representative of the situation in vivo.

The confirmatory test for the efficacy of anti-HCV drug candidates are performed in nonhuman primates, with chimpanzee as an acceptable animal model. The use of chimpanzees is expensive, requires a high quantity of the test materials, and is considered by many people to be inhumane.

A further complication towards treatment is the multiple genotypes of HCV. The most commonly used classification of Hepatitis C virus has HCV divided into the following genotypes: 1, 2, 3, 4, 5, 6, 7, 8, 9, 10 and 11. The HCV genotypes are broken down into sub-types, some of which include: 1a, 1b, 1c; 2a, 2b, 2c; 3a, 3b; 4a, 4b, 4c, 4d, 4e; 5a; 6a; 7a, 7b; 8a, 8b; 9a; 10a; and 11a. It is believed that the hepatitis C virus has evolved over a period of several thousand years to result in the current general global patterns of genotypes and subtypes, as listed below:
1a—mostly found in North and South America; also common in Australia;
1b—mostly found in Europe and Asia;
2a—is the most common genotype 2 in Japan and China;
2b—is the most common genotype 2 in the U.S. and Northern Europe;
2c—the most common genotype 2 in Western and Southern Europe;
3a—highly prevalent here in Australia (40% of cases) and South Asia;
4a—highly prevalent in Egypt;
4c—highly prevalent in Central Africa;
5a—highly prevalent only in South Africa;
6a—restricted to Hong Kong, Macau and Vietnam;
7a and 7b—common in Thailand;
8a, 8b and 9a—prevalent in Vietnam;
10a and 11a—found in Indonesia;

In North America, genotype 1a predominates, followed by 1b, 2a, 2b, and 3a. In Europe, genotype 1b is predominant, followed by 2a, 2b, 2c and 3a. Genotypes 4 and 5 are found almost exclusively in Africa. The discovery of anti-HCV drugs is complicated by that HCV of different genotypes are known to have different responsiveness to treatment. For instance, genotypes 1 and 4 are less responsive to interferon-based treatment than genotypes 2, 3, 5 and 6. An ideal screening assay for the discovery of anti-HCV agents would allow the evaluation of the agents towards HCV of multiple genotypes.

Ito et al teaches that hepatocytes cultured from HCV patients continue to support HCV replication. See Ito et al. in Cultivation of hepatitis C virus in primary hepatocyte culture from patients with chronic hepatitis C results in release of high titre infectious virus. Journal of General Virology (1996), 77, 1043-1054.

Li teaches that cryopreserved hepatocytes can be cultured as monolayer cultures. See Li in Human hepatocytes: Isolation, cryopreservation and applications in drug development. Chemico-Biological Interactions 168 (2007) 16-29.

The inventor believes that there is a need for an effective screen for anti-HCV compounds that is representative of the situation in vivo as well as allowing the evaluation of the anti-HCV compounds towards multiple genotypes of HCV.

### SUMMARY

A method for the screening of anti-HCV drug candidates is described. In part, the novelty of the method is the banking of cryopreserved hepatocytes infected by different HCV genotypes isolated from livers of HCV-infected patients, culturing of such hepatocytes in multi-well plates, and screening for anti-HCV drug candidates for effectiveness towards to inhibition of HCV replication. The novelty and advantages of the method over the current art may include one or more of the following:

1. Banking of cryopreserved HCV-infected hepatocytes consists of multiple genotypes. The collection of hepatocytes from different patients infected by the multiple genotypes of HCV allows evaluation of anti-HCV compounds towards HCV of multiple genotypes.

2. Hepatocytes derived from HCV patients represent the actual infected cells in humans, and thereby would not have the potential artifacts of engineered cell lines or hepatocytes infected with HCV after culturing.

3. Culturing of hepatocytes from the cryopreserved HCV-hepatocyte bank for anti-HCV screening provides a supply of cryopreserved hepatocytes. The use of cryopreserved hepatocytes allows the cells to be fully characterized (e.g. genotyping of the HCV; rate of HCV replication). Screening for anti-HCV agents can be performed using the most appropriate cells. One of the more important advantages is that one can perform the screening using multiple lots of hepatocytes, with each lot representing cells infected by HCV of a specific genotype.

The inventor believes that this novel method can significantly enhance the efficiency of discovery of anti-HCV drugs.

Embodiments of the method for isolating and cryopreserving of hepatocytes may include one or more of the following features. For example, the HCV-infected liver may be firstly perfused with an isotonic salt solution containing a chelating agent for the clearing of blood. The second perfusing solution may be an isotonic salt solution with collagenase for the dissociation of the hepatocytes from the liver parenchyma. The collagenase concentration may be 0.5 mg/ml.

The dissociated hepatocytes are collected by centrifugation. The centrifugation may be a low speed centrifugation. The low speed centrifugation may be 50×g.

The collected hepatocytes can be further purified by density gradient centrifugation. The density gradient may be 30% by volume of Percoll®. The centrifugation may be 100×g.

The purified hepatocytes can be suspended in medium containing cryoprotectants for cryopreservation. The cryoprotectant may be DMEM/F12 medium supplemented with 10% fetal calf serum and 10% DMSO.

The hepatocytes may be cooled to a temperature of −70° C. at a rate of about −1° C./min using a programmable freezer. The hepatocytes may be stored at a temperature of about −150° C. or cooler. The temperature of about −150° C. or cooler may be achieved through a liquid nitrogen cryogenic storage system.

The details of various embodiments of the invention are set forth in the accompanying drawings and the description below. Other features and advantages of the invention will be apparent from the description, the drawings, and the claims.

### DESCRIPTION OF THE DRAWINGS

FIG. 1 is a schematic of a multi-well culture plate (96-well plate) with HCV-infected hepatocytes of the multiple HCV genotypes, and the evaluation of multiple potential anti-HCV compounds at multiple concentrations.

FIG. 2 is a flow diagram of an overall process for screening of anti-HCV agents.

### DETAILED DESCRIPTION

The inventor has developed an improved method for screening of anti-HCV drugs that may have efficacy for treating the hepatitis C virus. The method involves the isolation and cryopreservation of HCV infected hepatocytes from multiple infected individuals to compile a collection of hepatocytes that represent the various HCV genotypes. The isolated and cryopreserved hepatocytes are stored in a cryopreservation bank that represents the various genotypes of the hepatitis C virus. These stored hepatocytes then can be cultured in a culture medium, exposed to anti-HCV agents, and screened for HCV RNA or protein production. Using the cryopreservation bank of the genotypes of the HCV and multi-well culture plates, there is now the ability to simultaneously screen in parallel multiple anti-HCV agents against multiple HCV genotypes.

As in humans in vivo, the liver cells (hepatocytes) are the cells where HCV replication occurs. Therefore, human hepatocytes in a culture represent a physiologically relevant model for the evaluation of anti-HCV drugs. To obtain the hepatocytes, the cells are isolated from liver tissue and then preserved using cryopreservation. Thus, one of the aspects of the invention is the isolation and cryopreservation of hepatocytes obtained from the livers of HCV-infected patients.

One of the other aspects of the invention is the collection of hepatocytes from various HCV patients in numbers of patients sufficient to represent the various HCV genotypes. These hepatocytes are obtained from the liver tissue of the HCV infected patients and processed to isolate the cells from the liver tissue, preservation solution, blood, and the like.

The hepatocytes are stored in a cryopreservation bank and the cryopreserved cells later can be thawed and cultured for the production of the hepatitis C virus. One of the other aspects of the invention, therefore, is the culturing of the cryopreserved cells for replication as well as multiplication and therefore the production of the hepatitis C virus. Thus, the invention relates to the use of hepatocytes that are infected by HCV, and are capable of sustained production of the hepatitis C virus (HCV).

The production of the virus permits the hepatocytes to be used for the screening of agents that have the potential to inhibit HCV replication, and therefore have the potential to be further developed into anti-HCV drugs. The availability of hepatocytes infected by various, different genotypes of the virus allows screening of the effectiveness of different compounds towards each individual HCV genotype. Therefore, one of the aspects of the invention is to provide an effective tool for the discovery of inhibitors of the hepatitis C virus which can be further developed to be anti-HCV treatment agents.

The expression “replication of the HCV” designates the molecular process or processes leading to the synthesis of a strand of negative polarity which will serve to engender new strands of positive polarity constituting the genomic material of the HCV.

The expression “production of the HCV” describes the possibility for a given cell to reproduce infectious particles of the hepatitis C virus (viral multiplication cycle).

The expression “in a suitable culture medium” describes the medium in which the cell line is best able to grow. The culture medium can be in particular the DMEM/F12 medium with 10% FCS (fetal calf serum) medium supplemented by the elements necessary for the differentiated properties of human hepatocytes, particularly insulin, dexamethasone, selenium, and transferring.

The expression “RT PCR” designates real time polymerase chain reaction used for amplification of a piece of RNA across several orders of magnitude, generating a million or more copies of a particular RNA sequence.

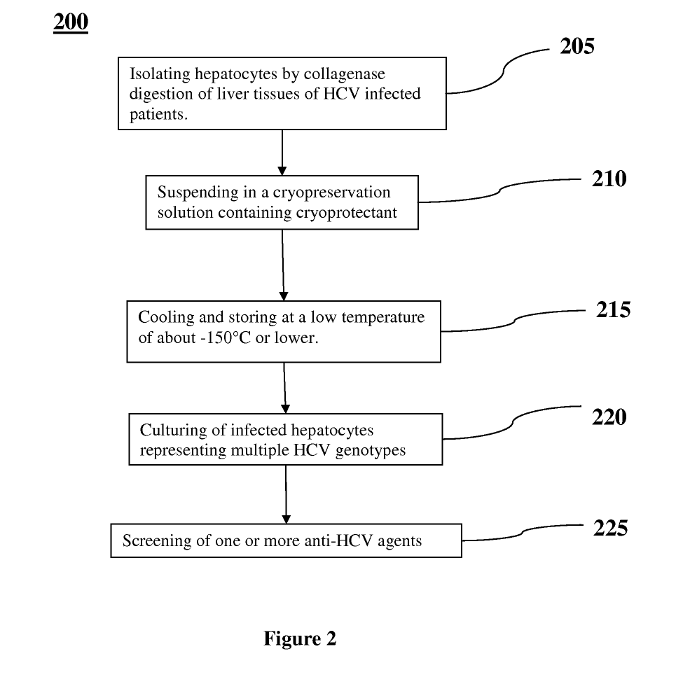

FIG. 2 illustrates the overall process 200 for screening of anti-HCV agents. In a first step 205, hepatocytes are isolated by collagenase digestion from livers obtained from patients infected with hepatitis C virus. In a second step 210, the isolated hepatocytes are then suspended in a suitable cryopreservation solution with cryoprotectant, such as DMEM/F12 medium with 10% fetal calf serum and 10% dimethyl sulfoxide. In a third step 215, the cells are cooled and stored in the cryopreservation solution at a suitable temperature, such as approximately −150° C. or lower.

To prepare the cells for screening of anti-HCV agents, the cells are cultured for hepatitis C replication (step 220). In this step, the cells are thawed and cultured on a suitable substratum, particularly collagen-coated or basement membrane proteins-coated plastic cell culture flasks or plates. The process of screening one or more anti-HCV agents (step 225) includes introduction of the various anti-HCV compounds into the culture medium containing the cultured hepatocytes representing multiple genotypes of HCV, the extraction of the total RNA of the cells, and the analysis of any reduction in the rate of synthesis of the HCV RNA of the cells relative to a control value corresponding to the rates of synthesis of the HCV RNA of the cells in the absence of the tested compounds.

### EXPERIMENTAL PROCEDURES

### Isolation, Cryopreservation, and Culturing of HCV-Infected Human Hepatocytes:

1. Human hepatocytes are isolated from livers of hepatitis C-infected patients by perfusion. The livers are obtained from organ procurement organizations (e.g. NDRI; IIAM).

2. The livers are first perfused with an isotonic solution (e.g. Hanks Balanced Salt Solution) to remove blood and organ preservation solutions, followed by perfusion with an isotonic solution containing a suitable concentration of collagenase (e.g. 0.5 mg/mL). The collagenase treatment digests the liver and releases highly viable hepatocytes.

3. The hepatocytes are washed by low speed centrifugation (e.g. 50×g) in an isotonic solution, and resuspended in a solution containing cryoprotectants (in particular, DMEM/F12 medium supplemented with 10% fetal calf serum and 10% dimethylsulfoxide. The collected hepatocytes can be further purified by density gradient centrifugation prior to resuspension. The density gradient may be 30% by volume of Percoll®. The centrifugation may be 100×g.

4. The cells are cryopreserved in a programmable freezer at a constant rate of freezing, particularly about −1° C./minute until a suitable low temperature, particularly about −70° C. or lower, is reached.

5. The cryopreserved cells are stored at a suitable temperature, particularly about −150° C. or lower, using a suitable apparatus, particularly a liquid nitrogen cryogenic storage system.

### Development of a Cryopreserved Hepatocyte Bank:

The cryopreserved cells above are collected together to form a cryopreserved hepatocyte bank. The hepatitis C virus is presently classified into six genotypes, with several subtypes within each genotype. Subtypes are broken down into quasispecies based on their genetic diversity. A collection (“bank”) of hepatocytes from multiple HCV patients allows a complete set of the multiple genotypes of HCV to allow studying the biology of the genotype and potential measures to inhibit the replication of the individual genotypes.

### Cells and Maintenance Conditions for HCV-infected Human Hepatocytes:

1. Hepatocytes of multiple HCV genotypes are retrieved from cryopreservation and thawed in a 37° C. water bath.

2. The cells are suspended in DMEM/F12 medium

3. The suspended cells are cultured in a thin layer in type I collagen-coated cell culture vessels (e.g. 6-, 12-, 24- or 96-well plates) and in a DMEM/F12 medium containing 10% of fetal calf serum (FCS), insulin (10 ug/mL), and dexamethasone (100 nM).

4. The cell culture vessels are customarily seeded with approximately 0.175 million cells per sq. cm (e.g. 0.35 million cells per well for 24-well plates).

5. After the cells are attached, the cells are overlaid with Matrigel® by changing the medium to that containing 0.25 mg Matrigel®. The culture medium is placed daily.

In step 3 above, the cells can be cultured in a variety of cell culture tools as are known in the art.

In another implementation, each vessel comprises a cup connected to the body and each cup has a top edge below the rim of the outer wall.

### Evaluation of HCV Production

Quantification of HCV production is important for the development of anti-HCV screens. The step involves:

1. Addition of RNA extracting solution into the cell culture vessels with HCV-hepatocyte cultures.

2. Sampling of the RNA extracting solution from the cell culture vessel for extraction and purification of RNA.

3. Quantifying the RNA of the HCV either by RT-PCR, or by hybridization of the RNA on filters. Moreover, if the viral infection does not lead to a lysis of the cells, the multiplication of the HCV can be observed by indirect immunofluorescence using antibodies directed against proteins of the HCV.

Process for Screening Anti-HCV Agents:

1. HCV-infected human hepatocytes that are known to produce HCV virus are subjected in parallel to the action of different, potentially anti-HCV, compounds (test articles) and at variable concentrations.

2. After incubation with the test articles, HCV content of the cultures is quantified by quantification of HCV RNA or HCV proteins.

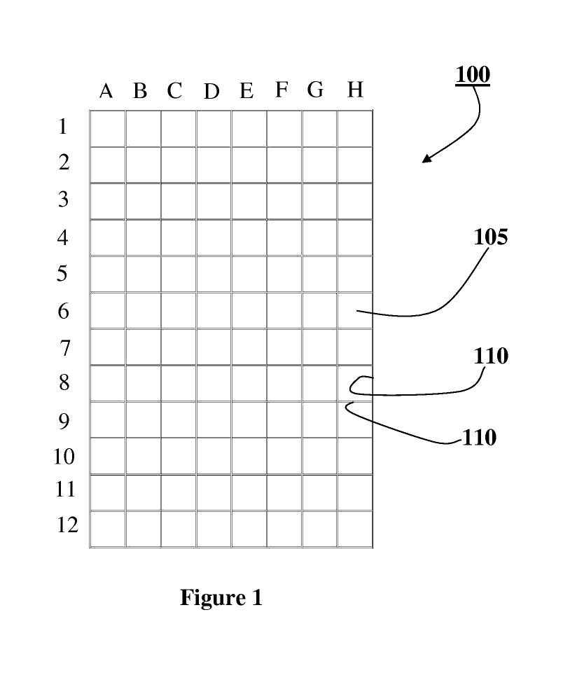

Referring to FIG. 1, the screening can be performed in a multi-well culture plate 100 (e.g., a 96-well plate) by using HCV-infected hepatocytes of the multiple HCV genotypes. The multi-well plate 100 includes wells 105 that are defined by walls 110. The columns A-H are used to test different anti-HCV agents for treating HCV. Thus, agent 1 is placed in each well of column A, agent 2 is placed in each well of column B, etc. The rows 1-12 are used to provide HCV infected cells representing the different genotypes and subtypes. For example, row 1 may be used for subtype 1a, row 2 may be used for subtype 1b, row 3 may be used for subtype 2a, row 4 may be used for subtype 3a, row 5 may be used for subtype 4a, etc. In this manner, multiple agents for treating HCV may be simultaneously tested on multiple genotypes and subtypes of HCV infections. This ability to simultaneously test multiple treatment agents against multiple genotypes will increase the speed and efficiency by which agents can be tested to treat HCV and thereby improve the likelihood that suitable treatment agents will be found quicker.

Characteristics of effective anti-HCV agents include a result of hepatocytes that can be used as anti-viral agents. Such hepatocytes may have different genotypes that can be used as anti-viral measures and thereby be genotype-specific. Another result may be that effective anti-HCV agents lead to a decrease in HCV content in the cultures.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A cryogenic hepatocyte bank, wherein the bank comprises multiple hepatocytes collected from multiple HCV patients, wherein the hepatocyte bank comprises more than one genotype of HCV.

2. A method for preparing a cryogenic hepatocyte bank comprising multiple hepatocytes collected from multiple HCV patients, the hepatocyte bank comprising more than one genotype of HCV, the method comprising preparing the cryogenic hepatocytes bank by isolating and cryopreserving human hepatocytes from the livers of HCV infected patients.

3. The method of claim 2, wherein isolating and cryopreserving the human hepatocytes comprises:
isolating tissue from liver of one or more HCV infected patients;
perfusing the tissue with a first perfusing solution to remove blood and organ preservation solutions;
perfusing the tissue with a second perfusing solution to release hepatocytes from the liver tissue;
washing the released hepatocytes by centrifugation;
resuspending the hepatocytes in a solution containing a cryoprotectant;
cooling the hepatocytes; and
storing the cryopreserved cells at a low temperature.

4. The method of claim 3, wherein the first perfusing solution is an isotonic salt solution.

5. The method of claim 3, wherein the second perfusing solution is an isotonic salt solution with collagenase.

6. The method of claim 3, wherein the collagenase concentration is 0.5 mg/ml.

7. The method of claim 3, wherein said centrifugation is a low speed centrifugation.

8. The method of claim 3, wherein the low speed centrifugation is 50×g.

9. The method of claim 3, wherein the cryoprotectant comprises DMEM/F12 medium supplemented with 10% fetal calf serum and 10% DMSO.

10. The method of claim 3, wherein said hepatocytes are cooled to a temperature of about −70° C. at a rate of about −1° C./min.

11. The method of claim 3, wherein said hepatocytes are stored at a temperature of about −150° C. or cooler.

12. A method of screening inhibitors of HCV replication using hepatocytes cultured from a bank of cryopreserved HCV infected hepatocytes, the method comprising:
retrieving and thawing the hepatocytes from the hepatocyte bank in a warm water bath;
suspending the hepatocytes in a medium;
culturing the hepatocytes;
conducting anti-HCV screening of the hepatocytes by subjecting HCV infected hepatocytes in parallel to the action of different anti-HCV compounds at one or more concentrations; and
quantifying the HCV content of the culture by quantification of HCV RNA or HCV protein.

13. The method of claim 12, wherein multiple HCV genomes are encompassed by hepatocytes from different donors, each infected by HCV of a specific genotype.

14. The method of claim 12, wherein quantification of HCV content of the culture is done by quantification of HCV RNA or HCV proteins.
